(19) United States
(12) Patent Application Publication
(10) Pub. No.: US 2020/0069008 A1
(43) Pub. Date: Mar. 5, 2020

(54) Cane Fabric Wrap

(71) Applicants: Charlotte Anne Heim, Arlington, MA (US); Stephen David Opie, Arlington, MA (US)

(72) Inventors: Charlotte Anne Heim, Arlington, MA (US); Stephen David Opie, Arlington, MA (US)

(21) Appl. No.: 16/552,677

(22) Filed: Aug. 27, 2019

Related U.S. Application Data
(60) Provisional application No. 62/724,344, filed on Aug. 29, 2018.

(51) Int. Cl. A45B 9/00; A45B 9/06; G09F 23/00

(52) U.S. Cl. CPC A45B 9/00; A45B 9/06; A45B 2009/005; A45B 2009/002; A45B 2200/05; G09F 23/00

(57) ABSTRACT

Cane fabric-wraps are attachable and removable stretch fabric/foam wraps that once applied to a standard walking cane add new features to the cane and alter the shape, color and overall appearance of a traditional cane silhouette. The cane fabric wraps can have reflective elements for nighttime visibility on the front or visible surface, permanent address labels on the back or hidden surface and silicon material pieces (on the back surface) to prevent the wrap from sliding downwards when the cane is in use. The fabric wraps are typically secured to the cane with a three-step process. First with a snap at the top edge, secondly with a full-length hook & loop tape, and thirdly with a snap at the bottom edge. These three steps allow for installation onto the cane and removal from the cane. The overall shape of the wrap is designed to provide a large area for a variety of design and color application and also room for the reflective elements to be placed.

### RELATED APPLICATIONS

This application claims the benefit under 35 USC 119(e) of U.S. Provisional Application No. 62/724,344, filed on Aug. 29, 2018, which is incorporated herein by reference in its entirety.

### SUMMARY OF THE INVENTION

The present invention relates to the field of personal and domestic articles, more specifically, mobility devices (walking stick, utility cane with shepherd's or offset handle, quad or tri-canes) combined with an interchangeable, reflective, personalized and slide-free fabric wrapping sleeve.

The cane fabric wraps are visual and technical enhancements to traditional mobility devices often referred to as a mobility assistance device. The fabric wraps wrap around a walking cane already sized for use. The fabric wraps include a piece of stretchable foam, a top and back fabric cover, an additional top fabric cover, 4 snaps, 2 strips of hook & loop fasteners, stitching, reflective and non-reflective vinyl, an address label and 2 silicon tape pieces.

In general, according to one aspect, the invention features a wrap for a mobility device. The wrap comprises a fabric body and a closure system for attaching the fabric body to a shaft of the mobility device.

The fabric body typically includes stretchable fabric and/or foam. Further, the closure system typically includes one or more snaps, hook and loop strips, zipper, and/or elastic cord,

Films are preferably included on an inner side of the fabric body for preventing the fabric body from sliding down the shaft.

In addition reflective film elements on the fabric body are sometimes included.

In illustrated embodiments, a shape of the fabric body is rectangle with two beveled corners.

The wrap might further comprises a removable and reusable identification card holder.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

In the accompanying drawings, reference characters refer to the same parts throughout the different views. The drawings are not necessarily to scale; emphasis has instead been placed upon illustrating the principles of the invention. Of the drawings:

FIG. 1 is a front (exposed) view of an embodiment of the inventive fabric wrap.

FIG. 2 is a side view of an embodiment of the fabric wrap.

FIG. 3 is a back (hidden in normal use) view of an embodiment of the fabric wrap.

FIG. 4 is an exploded view of the materials that compose the package.

FIG. 5 is a orthographic view of the fabric wrap shown prior to assembly onto the cane.

FIG. 6 is an orthographic view of the fabric wrap assembled onto the cane.

FIG. 7 is a cross-sectional view of the cane and the Snap Location Register of the fabric wrap.

FIG. 8 is a cross-sectional view of the cane and the Hook and Loop Strips.

FIG. 9 is a cross-sectional view of the cane and the Silicon Friction Film.

FIG.10 is a view of the outer shape of the fabric wrap.

FIG. 11 is a view of the fabric wrap shape when it is on the cane.

FIG. 12 is a view of the fabric wrap shape on the cane with the cane included.

FIG. 13 is a side view of the zippered fabric wrap mounting method option.

FIG. 14 is a front view of the zippered fabric wrap mounting method option.

FIG. 15 is a back view of the zippered fabric wrap mounting method option.

FIG. 16 shows a zippered fabric wrap mounting method option.

FIG. 17 shows a zippered wrap-around mounting method option.

FIG. 18 is an orthographic view of an interlocking wrap-around mounting method option.

FIG. 19 is an orthographic view of an interlocking placard wrap-around mounting method option.

FIGS. 20 and 21 show an interlocking one-piece mounting method option.

FIGS. 22, 23, 24, 25, 26, and 27 are views of a removable and non-removable identification label option.

FIGS. 28, 29, and 30 show an attached identification label option.

FIG. 31 is a photo of a surface tension option between the package and the cane.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The following detailed description is merely exemplary in nature and is not intended to limit the described embodiments of the application and uses of the described embodiments. Any implementation described herein as “exemplary” or “illustrative” is not necessarily to be construed as preferred or advantageous over other implementations. All of the implementations described below are exemplary implementations provided to enable persons skilled in the art to practice the invention and are not intended to limit the scope of the appended claims. Furthermore, there is no intention to be bound by any expressed or implied theory presented in the preceding technical field, background, brief summary or the following detailed description.

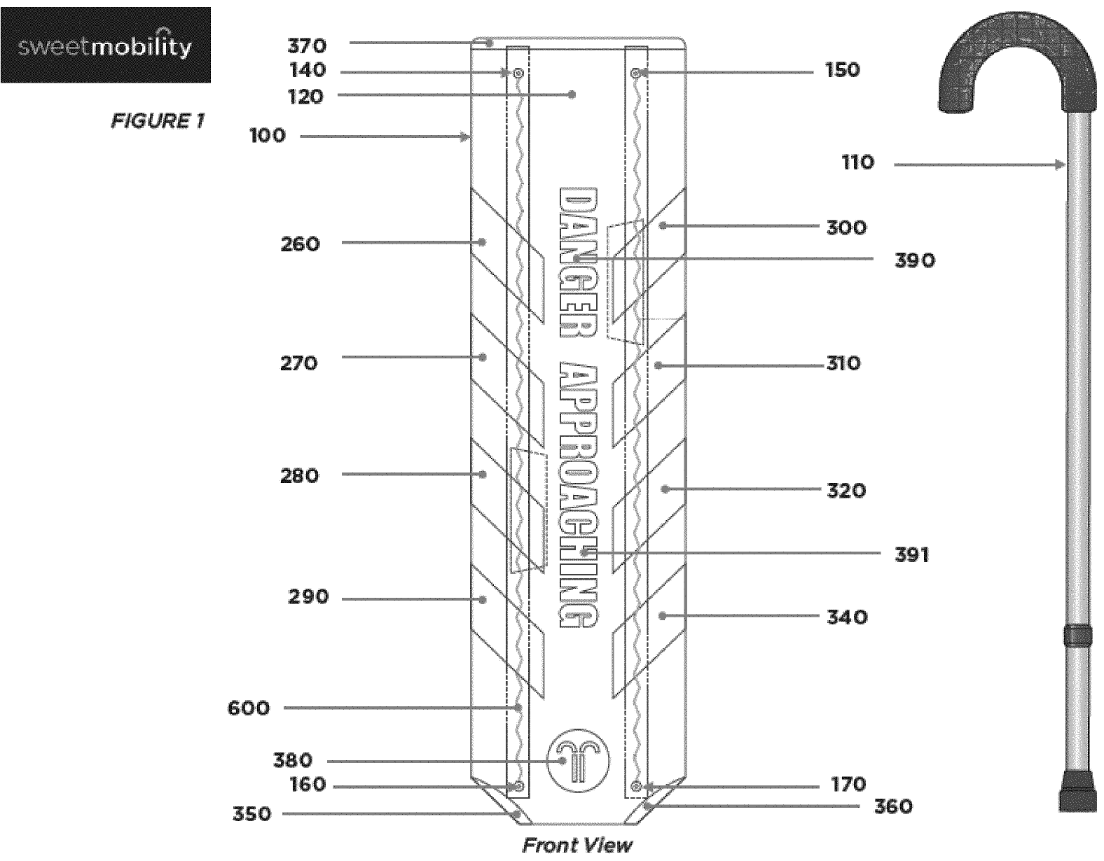

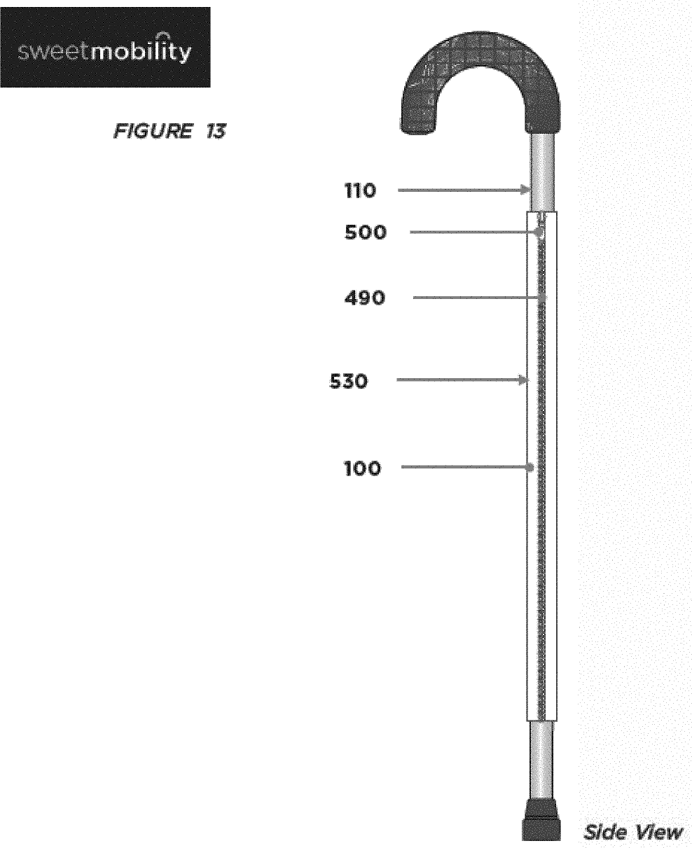

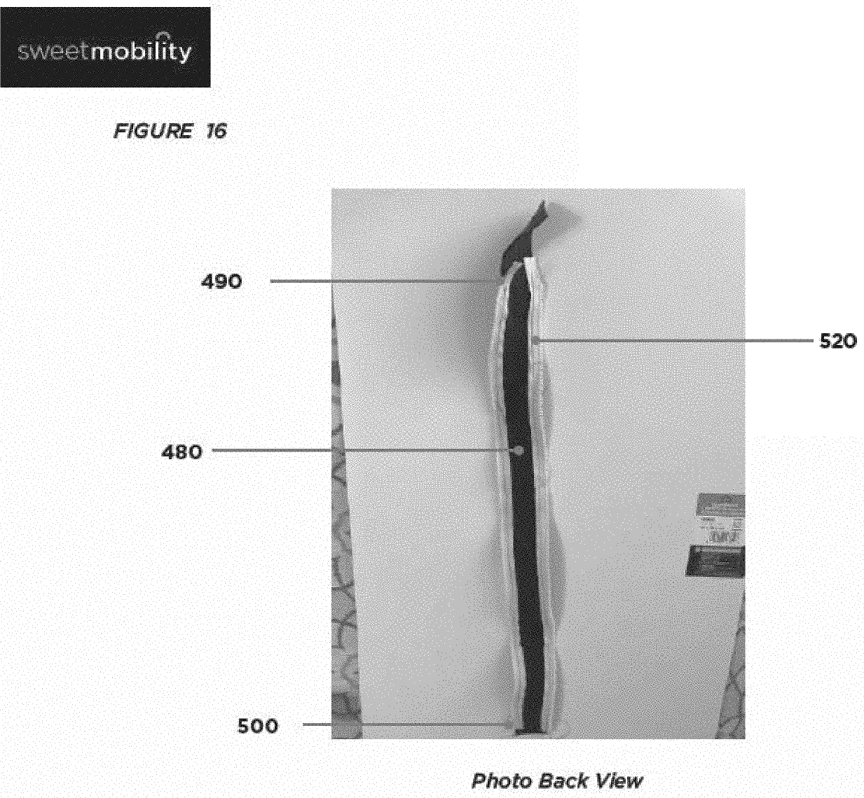

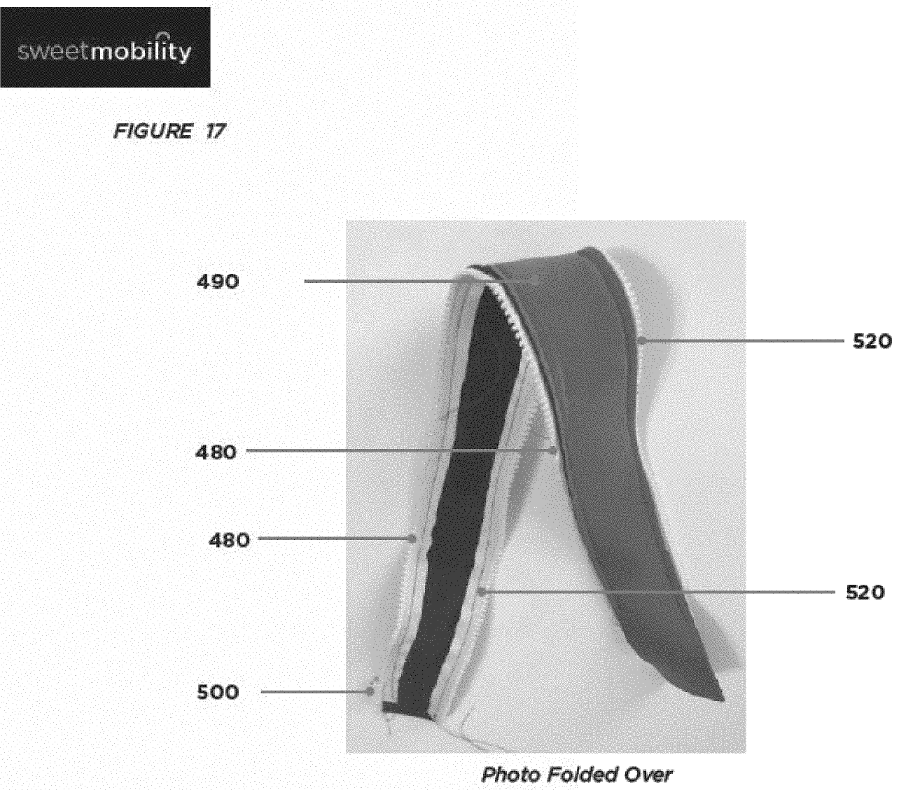

Detailed reference will now be made to one or more potential embodiments of the disclosure, which are illustrated in FIGS. 1 through 31.

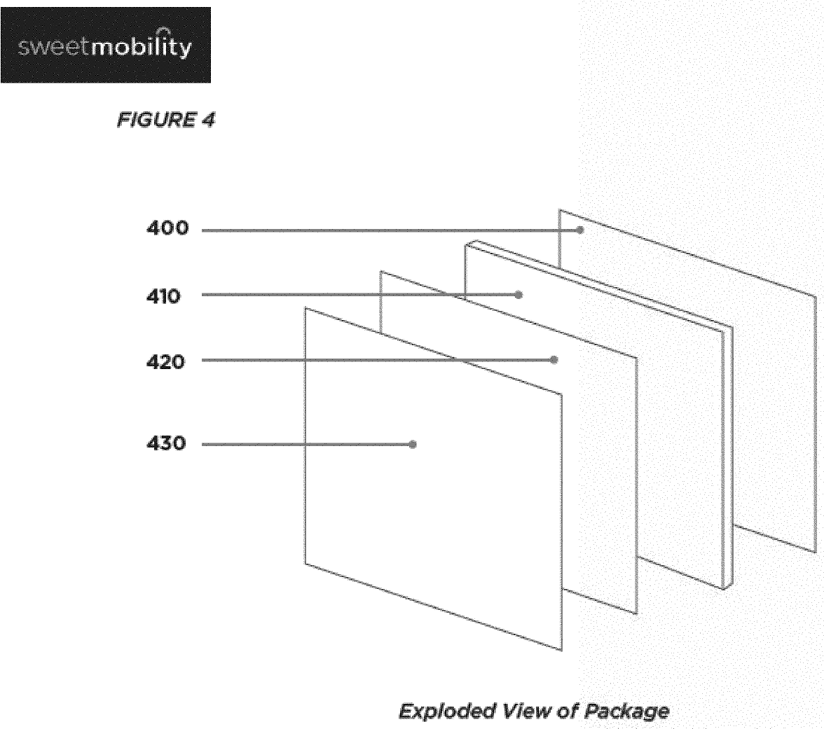

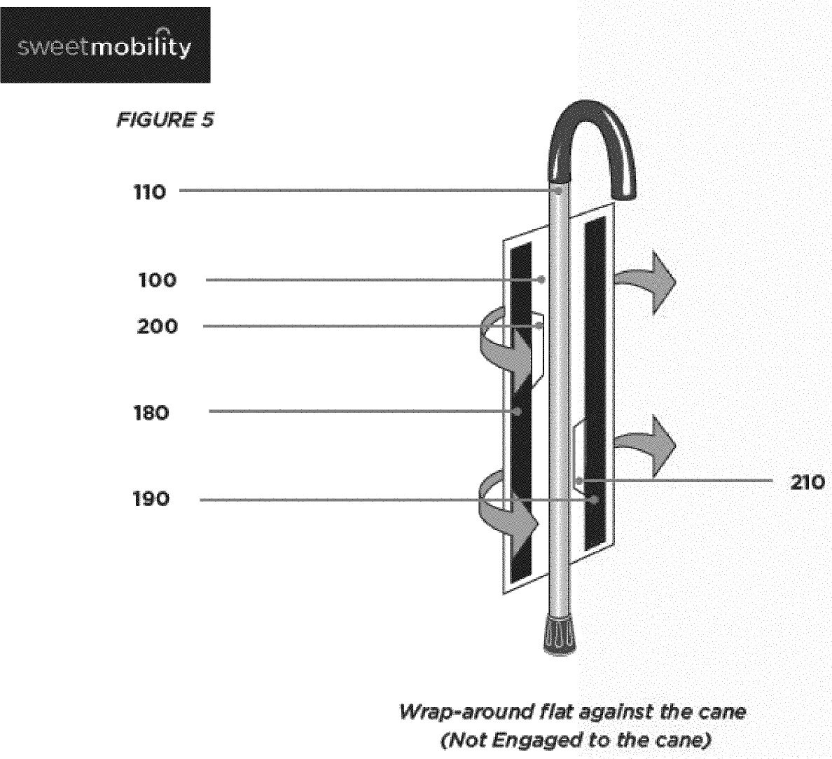

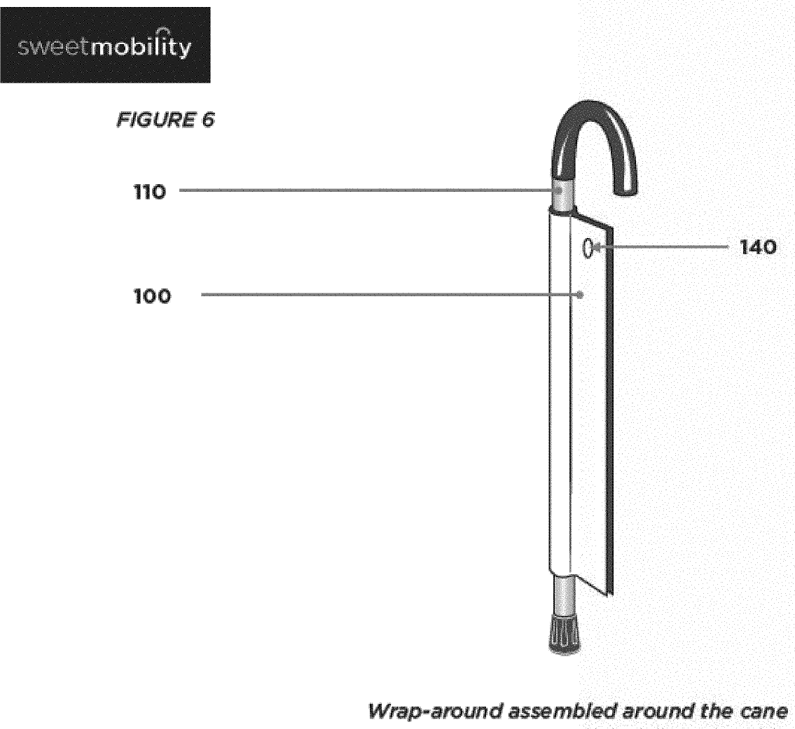

The material that embodies the main part of the product 100 (hereinafter fabric wrap) (FIG. 1) is an enhancement for a mobility assistance device or standard 1″ diameter metal or wooden cane 110. The fabric wrap 100 is configured for use with a cane 110, which is used as an assistive mobility device by a person and specifically wraps around a shaft of the cane. The fabric wrap fabrication (FIG. 4) is centered upon a stretchable foam 410 that is comprised of a nylon 4-way or 2 way stretch fabric top cover 420 and a nylon fabric 4-way or 2-way stretch back cover 400 to form a body of 1.5 mm in thickness. These stretchable fabrics 400/420 are laminated to the stretchable foam 410 to create an even surface free of voids, ruffles or gaps 120. The fabric wrap is fully stretchable in all directions throughout the materials itself. The stretchable foam 410 may be covered on both sides by the nylon or only one side for the fabric wrap to work. This stretchability allows for the fabric wrap to fold over the tube of a cane and perform the primary function of wrapping (FIG. 6).

The stretchable foam (FIG. 4) 410 may be covered on the inside and outside surfaces with an equally or non equally stretchable fabric 400/420. The stretchable foam 410 may be closed or open cell. In addition, other fabrics may be substituted—this includes woven air meshes with synthetic stretch top covers, and any 4-way or 2-way combination of stretch fabrics. Furthermore, the other fabrics can be stretchable in only certain areas and non-stretchable in others. This is achieved by using stretch materials in combination with molded non-stretch TPU (Thermo-Plastic Urethane) shapes on top of the stretch materials thereby negated the stretch where the molded TPU is applied.

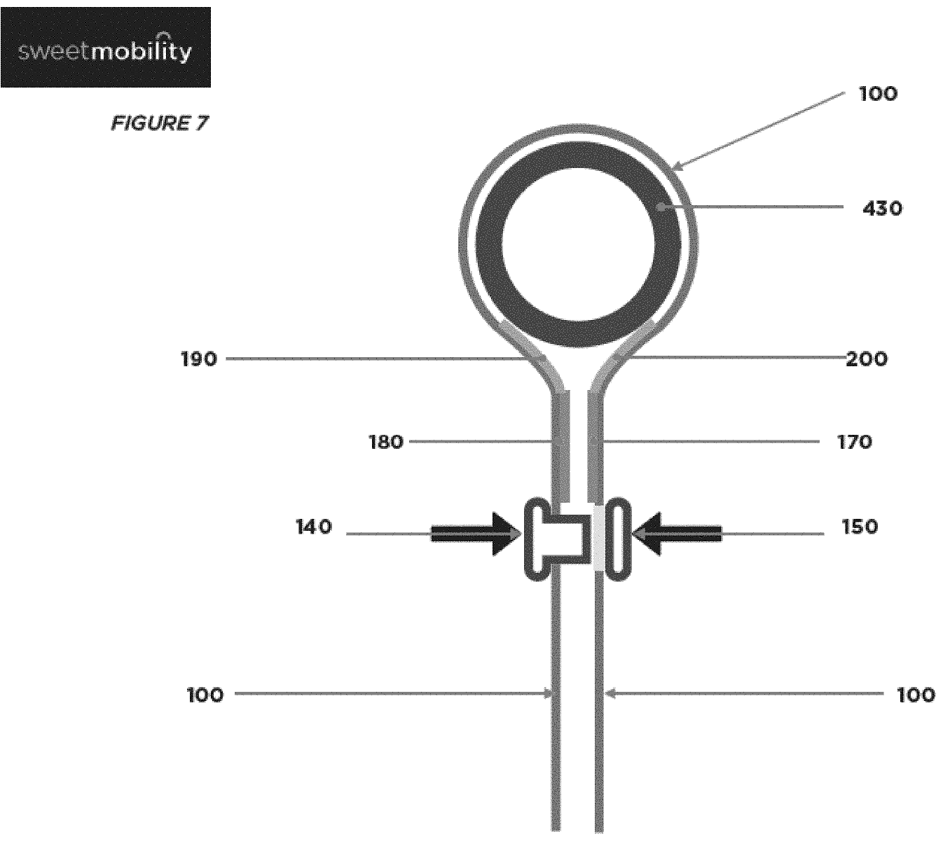

The fabric wrap is initially registered (FIG. 4) around the cane (FIG. 5) by the use of the top snap 140/150 of a closure system. The male half of the snap (FIG. 7) 140 is closed upon the female end 150 and when completed creates a semi-permanent registration or “hold” for the user to let go of the fabric wrap 100. The fabric wrap will remain on the cane without falling off (FIG. 6) or moving significantly. This positioning of the fabric wrap against the cane is solely the register. Sometimes, no other point of contact exists between the fabric wrap 100 and the cane 110. This register 140/150 positioning allows the user to use both hands to move to the next step of securing the fabric wrap 100 to the cane 110. The register 140/150 allows the user to let go of the fabric wrap and independently hold the handle of the cane 110 without holding onto the fabric wrap at all. The fabric wrap and the cane are now attached but are independent of each other.

After securing the fabric wrap to the cane itself with the top register, the two hook & loop strips of the closure system (FIG. 5) (hereinafter strips) are compressed against each other for the full length of the cane, fabric wrap and the strips 180/190. This assembly (FIG. 8) secures the hook and loop connection 180/190 and anchors the fabric wrap to the cane 110 but often does not prevent the fabric wrap from sliding up and down the cane tube 430. This position serves to create a straightening of the fabric wrap against the cane for an even transitioning on the left and right side of the fabric wrap. This position allows the user to adjust and readjust the hook and loop strips 180/190 so the fabric wrap covers the exposure of the back surface on either the inside or outside front surface. During this positioning the fabric wrap becomes further tightened against the cane tube 430 (FIG. 5) and begins to activate the surface tension of the internal tension films (heretoafter films) 200/210. These two films 200/210 are attached to the fabric wrap by the stitching 220/230 that also connects the strips 180/190 to the fabric wrap. The two films 200/210 are not connected in any other way to the fabric wrap. The stitching 220/230 runs the entire length of the strips 180/190 and is centered upon the strips length-wise.

At the bottom of the strips are the male and female bottom snap 160/170 to further tighten the bottom edge of the fabric wrap to the cane. The snaps 140/150/160/170 also serve to anchor the top and bottom edge of the strips 180/190 to the fabric wrap and prevent delamination between the strips and the fabric wrap.

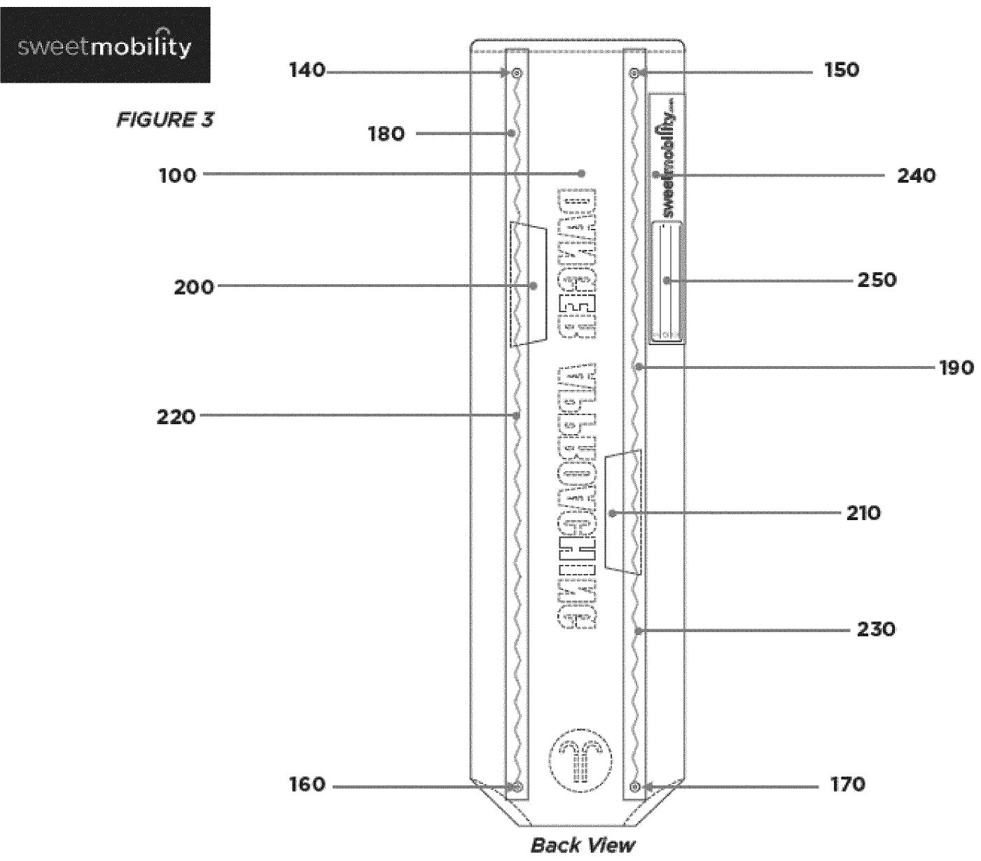

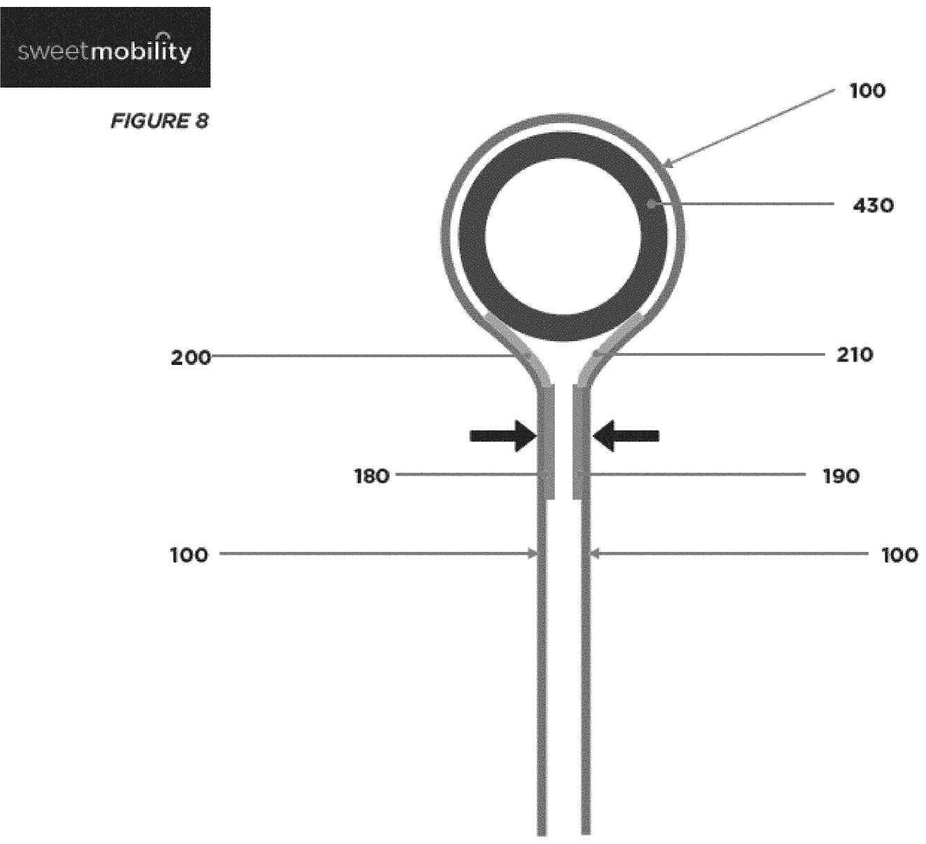

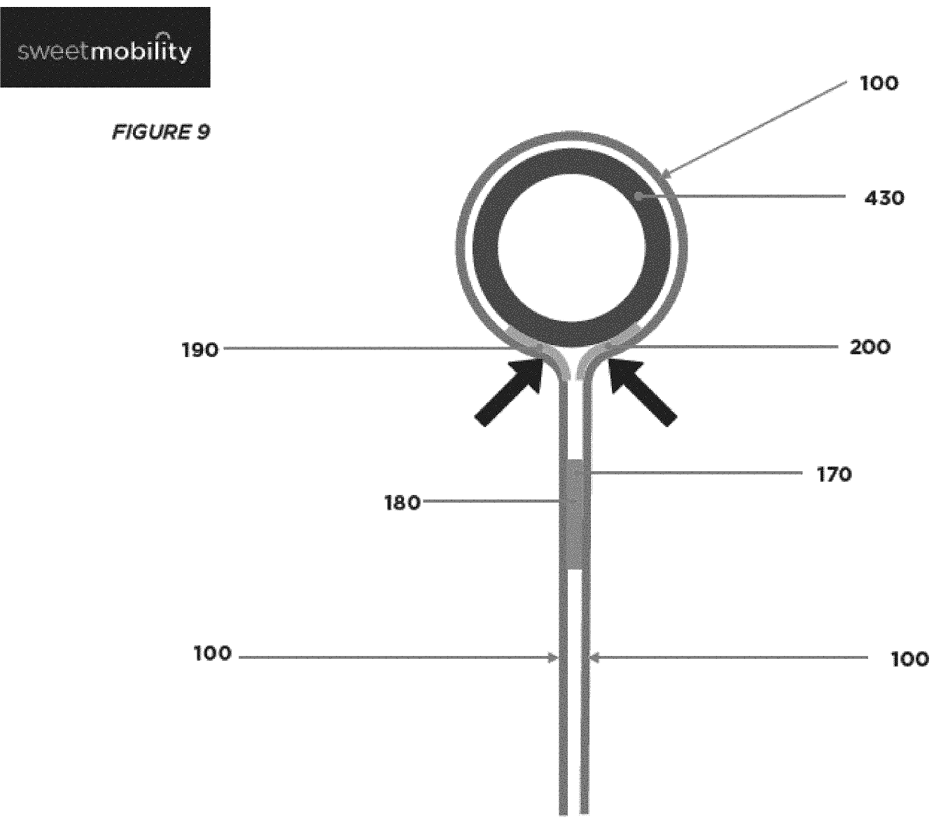

The films (FIG. 9) 200/210, upon hand-pressure (FIG. 6), press against the shaft of the cane 110/430 and create surface tension or friction. The surface tension or friction keep the fabric wrap in place (not moving) (FIG. 9) in both a static position and during the active walking motion of using the cane. This surface tension is released when the fabric wrap is disengaged (FIG. 5). The films 200/210 remain on the disengaged fabric wrap and do not remain engaged with the cane 110 in any way, shape or form. There is no damage to the cane 110 from the films 200/210. These films 200/210 are 0.025 mm thick and cover an area of up to 4.25″×1″. The location of the films 200/210 are not parallel from the left to the right. One side is located nearer to the top edge of the fabric wrap roughly ⅓rd of the distance down the package. The other side film is located nearer the bottom edge of the fabric wrap roughly ⅓rd of the distance up the package. This location (FIG. 3) ensures that the films 200/210 do not overlap and are located evenly along the shaft of the cane 110/430. The location ensures that the surface tension is evenly spread in the body area of the fabric wrap (FIG. 5) and is spread evenly on the cane 110/430 surface.

The fabric wrap has a permanent identification label 240 that is applied to the back surface, (hereinafter label) (FIG. 3). This label 240 is registered against the right hand upper corner outer edge. The label is heat transfer and features icons and scribe lines for the user to write upon 250 and serves to contain the users contact information. It is located on the internal surface (FIG. 3) to be hidden from view when the fabric wrap is in the engaged state on the cane (FIG. 6). The label's location on the back side (FIG. 3) also protects the label for external elements such as heat and moisture to further protect the contact label's writable area 250 from exposure and wear & tear. The label 240/250 is hidden to remove the contact information from sight and further protect the user's contact information from nefarious intent.

Located on the front side surface of the body of the fabric wrap (FIG. 1) are reflective film elements (hereto-after elements). These elements 260 thru 380 are 0.25 mm thick and are transfer films of wide angle, exposed retro reflective lenses bonded by a heat activated adhesive. These elements are silver in color during the daytime and are highly reflective at night. The elements are located on the top edge 370, the body 260 thru 340, the lower edge 350/360 of the wrap-around, and the circle element 380. The top edge element 370 defines the top shape and the lower edge elements 350/360 define the lower shape of the wrap. The elements in the body of the fabric wrap 260 thru 340 may vary in size, location and amount. The body area (FIG. 800 may contain no elements while other models have many elements in the body. All models contain the top edge elements 370, the bottom edge elements 350/360, and the circle element 380. The circle element is centered to appear at the front of the fabric wrap so that when reflecting light it is positioned directly in front of the user.

Located on the front side surface of the body of the fabric wrap (FIG. 1) are letters that convey sayings or messages as part of the design of the fabric wrap. These elements 390/391 are 0.25 mm thick and are transfer films applied with heat.

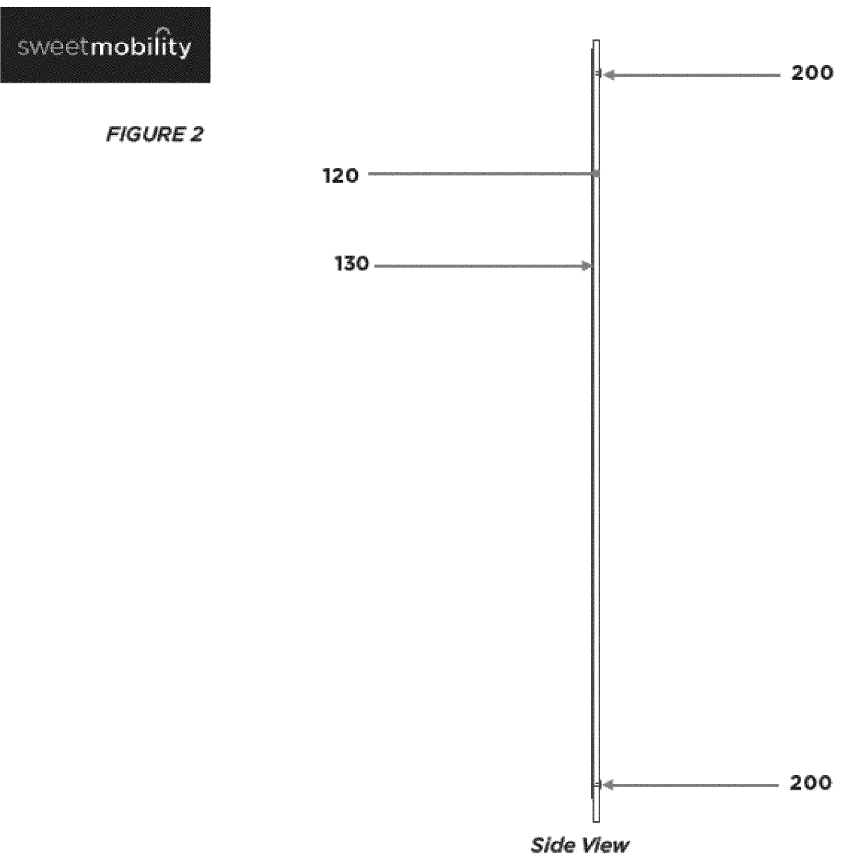

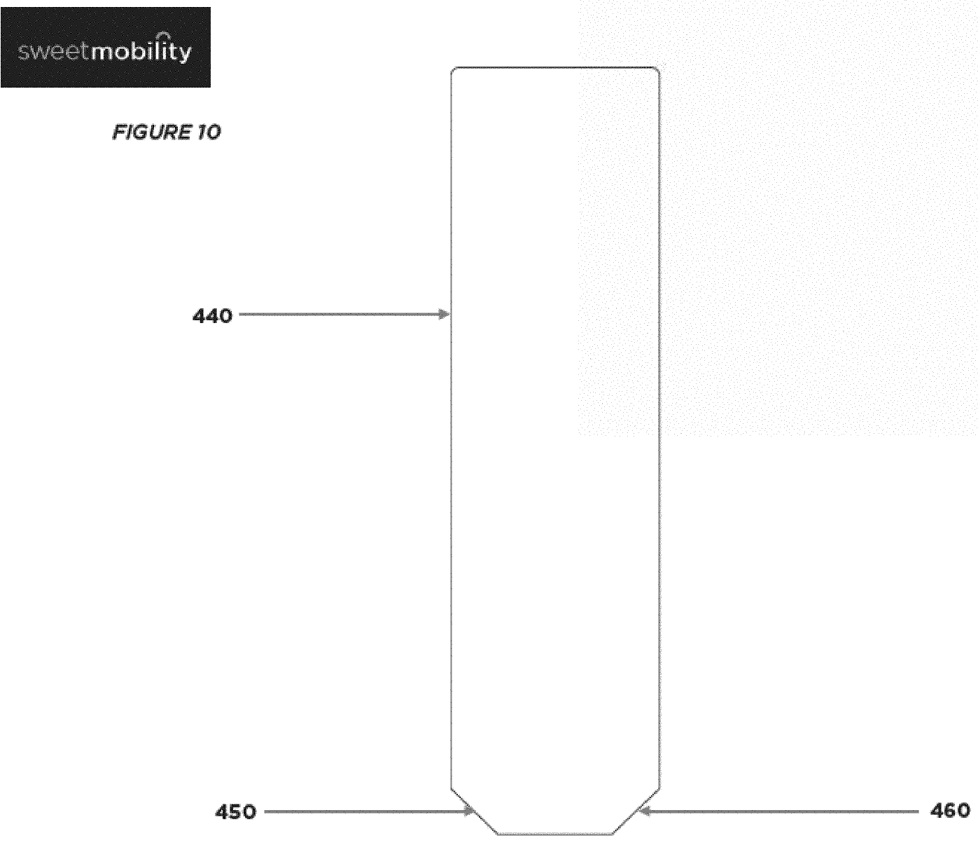

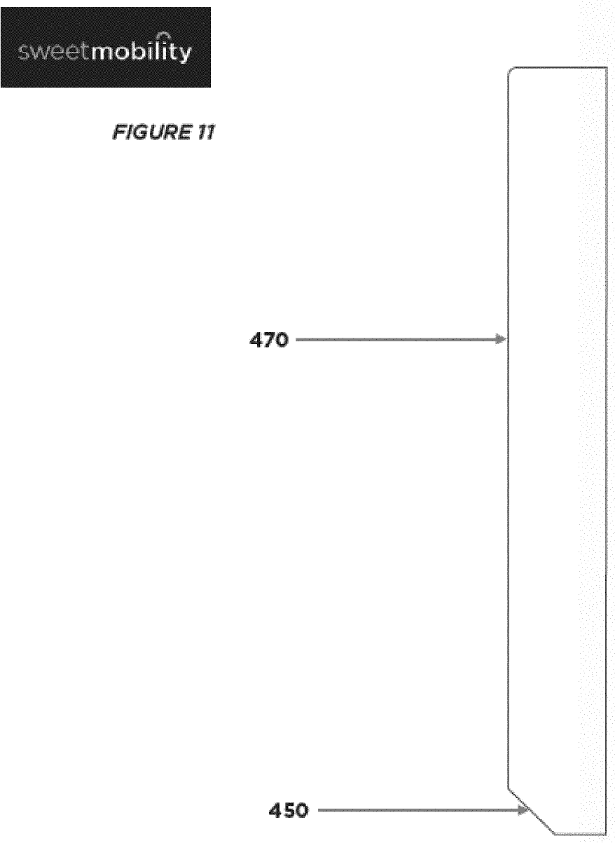

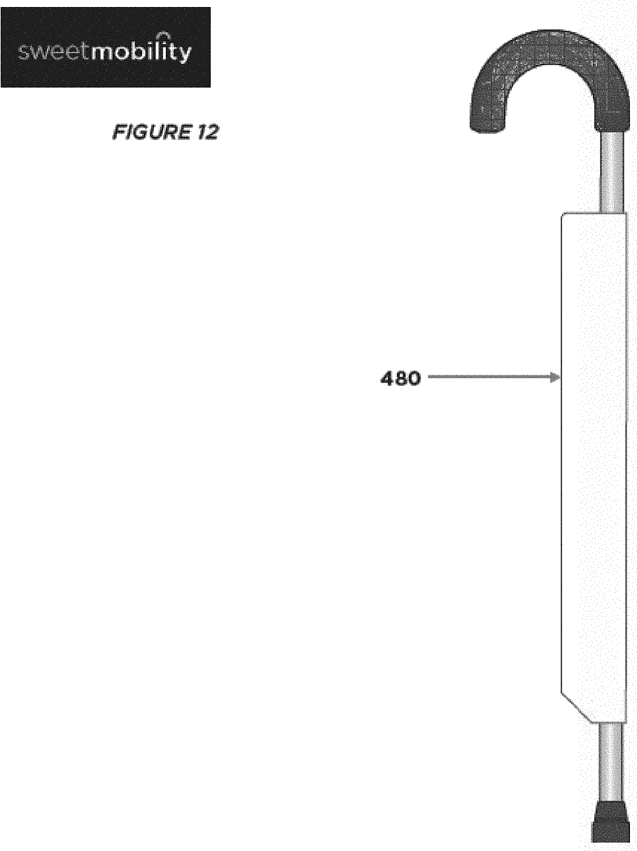

The overall shape of the fabric wrap (FIG. 10 is a rectangle except for two beveled corners on the bottom short side 450/460. These beveled corners 450/460 serve to indicate that this side is the bottom of the fabric wrap and closest to the ground. The fabric wrap 100 when in a non-engaged state is flat and takes no shape other than it's inherent flatness (FIG. 2). It is flat and not wrapped around the cane 110. Upon assembly to the cane, the fabric wrap takes on a new shape (FIG. 11). The second shape 470 is formed when the fabric wrap is wrapped around a cane. This shape 470 changes the inherent shape of a cane and becomes part of the brand identity. The fabric wrap 100 when assembled (FIG. 12) onto the cane 110 redefines the cane shape from a world wide, cross-cultural, long-established silhouette into a new profile (480) that is distinctive and defining.

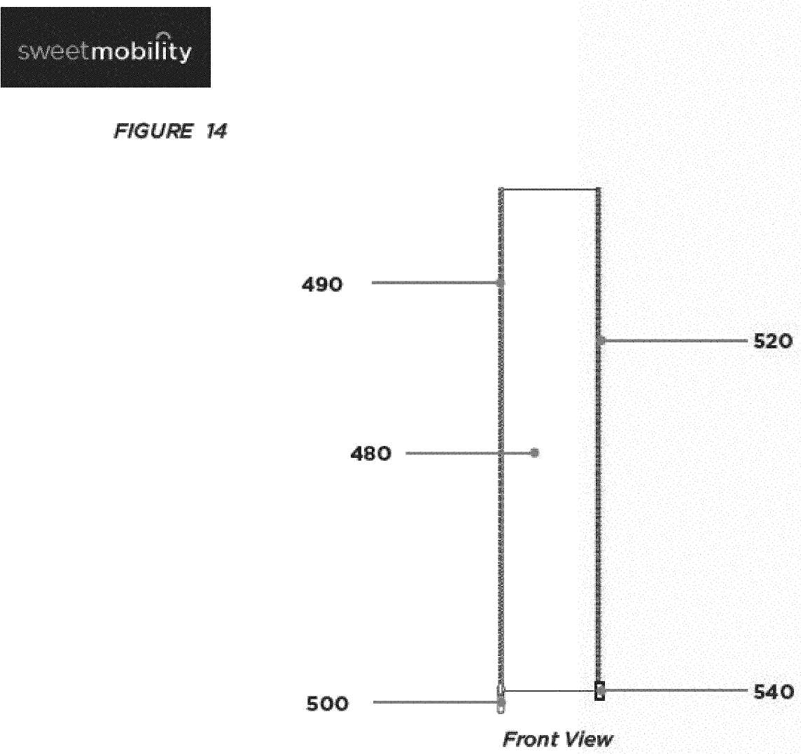

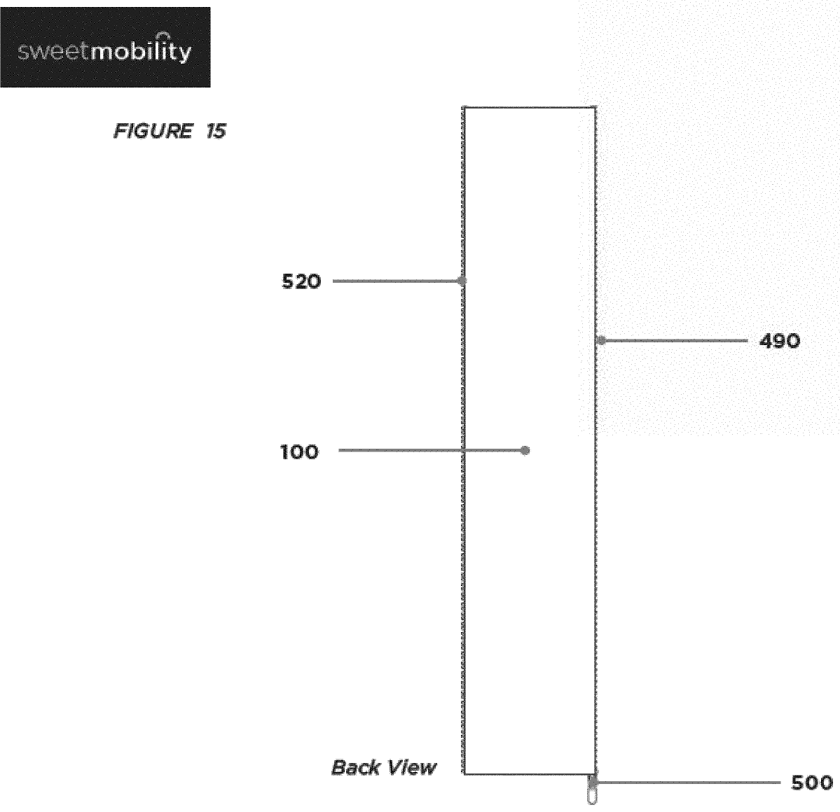

FIG. 14 represents a closure system including a zipper 530 with the package 100. The zipper construction 520 (FIG. 15) comprises four pieces, the left teeth 490, the right teeth 520 and the zipper pull 500 and the slider 540. When the teeth 490/520 are engaged they form a chain 490. The teeth 490/520 transverse from the base of the fabric wrap 100 to the top of the package 100. When the chain 490 is formed it secures the fabric wrap 100 to the cane 110.

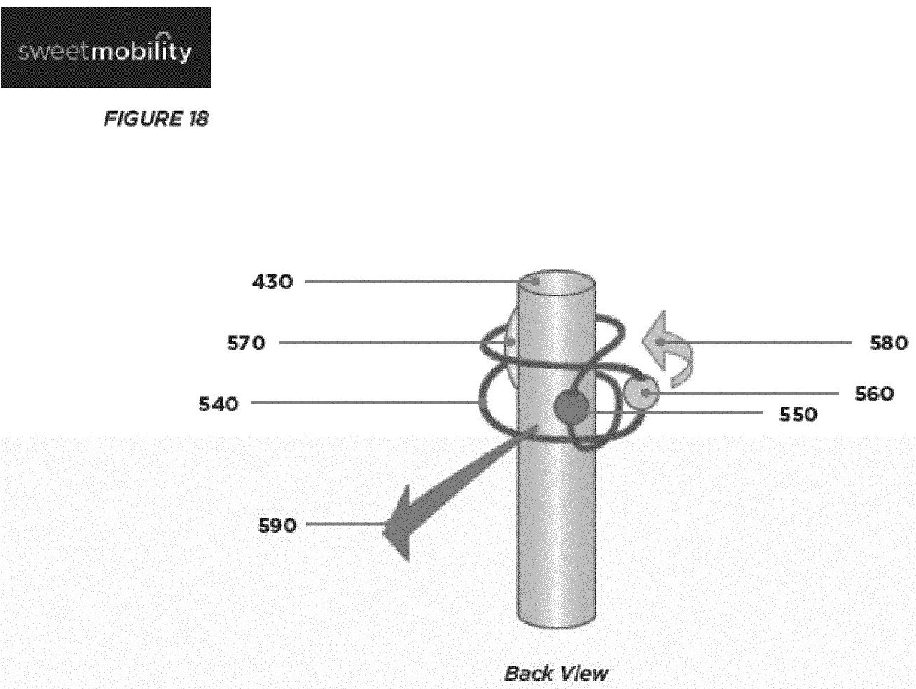

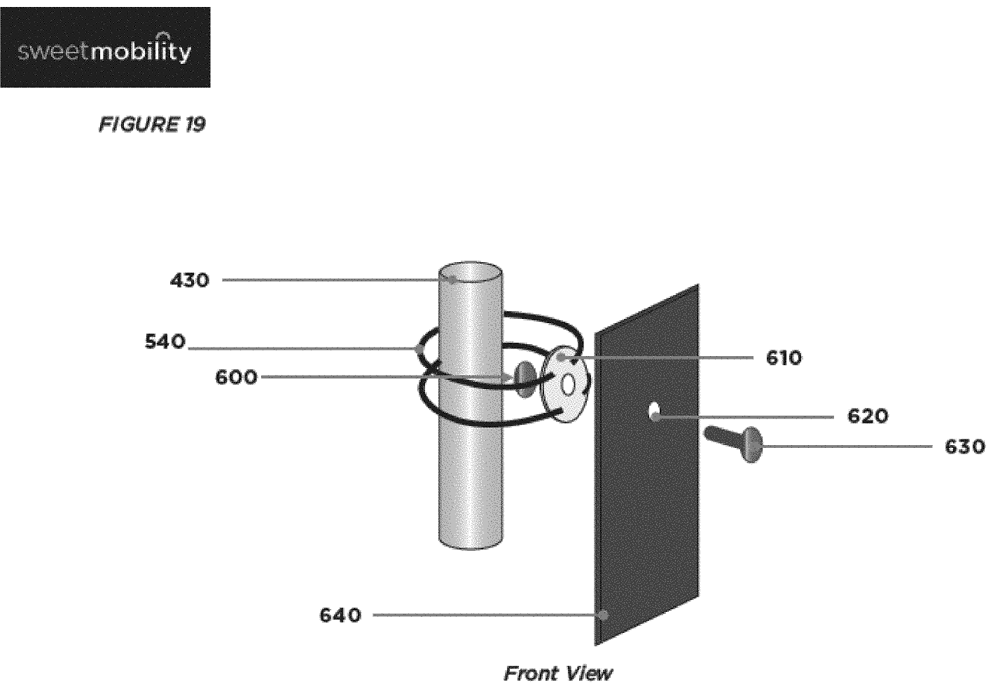

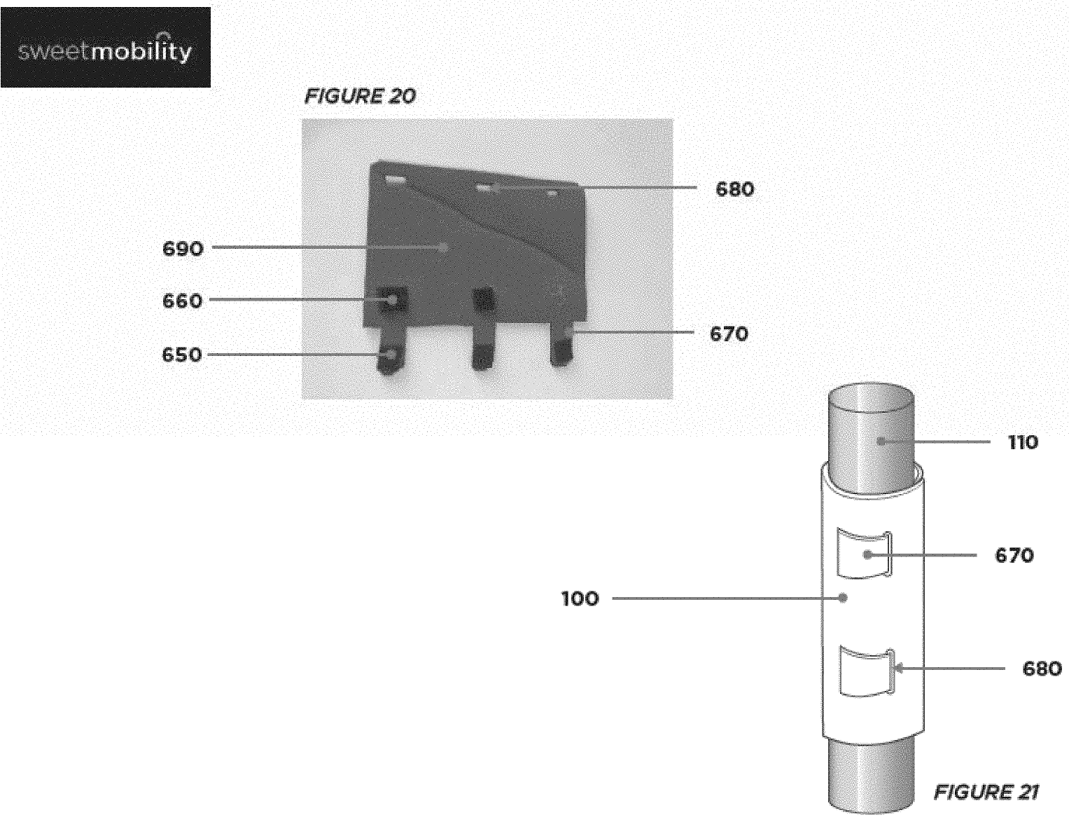

FIG. 18 represents an elastic cord assembly 540 of a closure system (hereinafter cord) that surrounds the cane 110 and secures a placard (FIG. 20) to the cane in one operation. The cord 540 is comprised of a loop of elastic cord that weaves through two round knobs 550/560 which are static on the cord. The knobs 550/560 loop over each other 580/590 and create a tight fit against the cane 110/430. The cord also travels through four openings in the flat circular disc 610 (FIG. 19). This flat circular disc serves to spread the tension of the cord and anchor the placard 640 to the cord assembly. The placard 640 is attached to the cord assembly through a threaded cylindrical screw and secured with a threaded post.

FIG. 20 represents a one-piece fabric wrap 690 design with hook and loop fasteners 650/660. The fabric wrap 100 wraps around the cane 110 and the extension flaps 670 push extend through the perforated capsule holes 680 and then connect the hook 660 to the loop 650 fasteners. This connection (FIG. 21) serves to anchor the one-piece fabric wrap 690 to the cane 110.

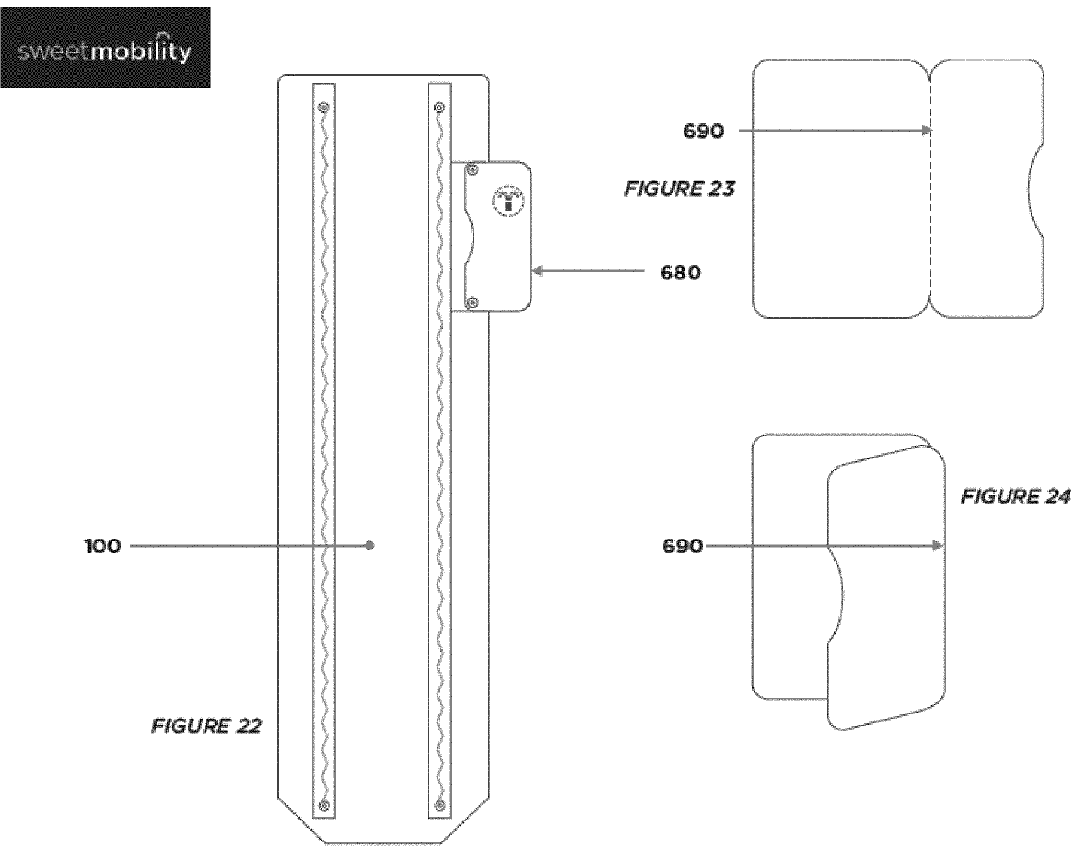

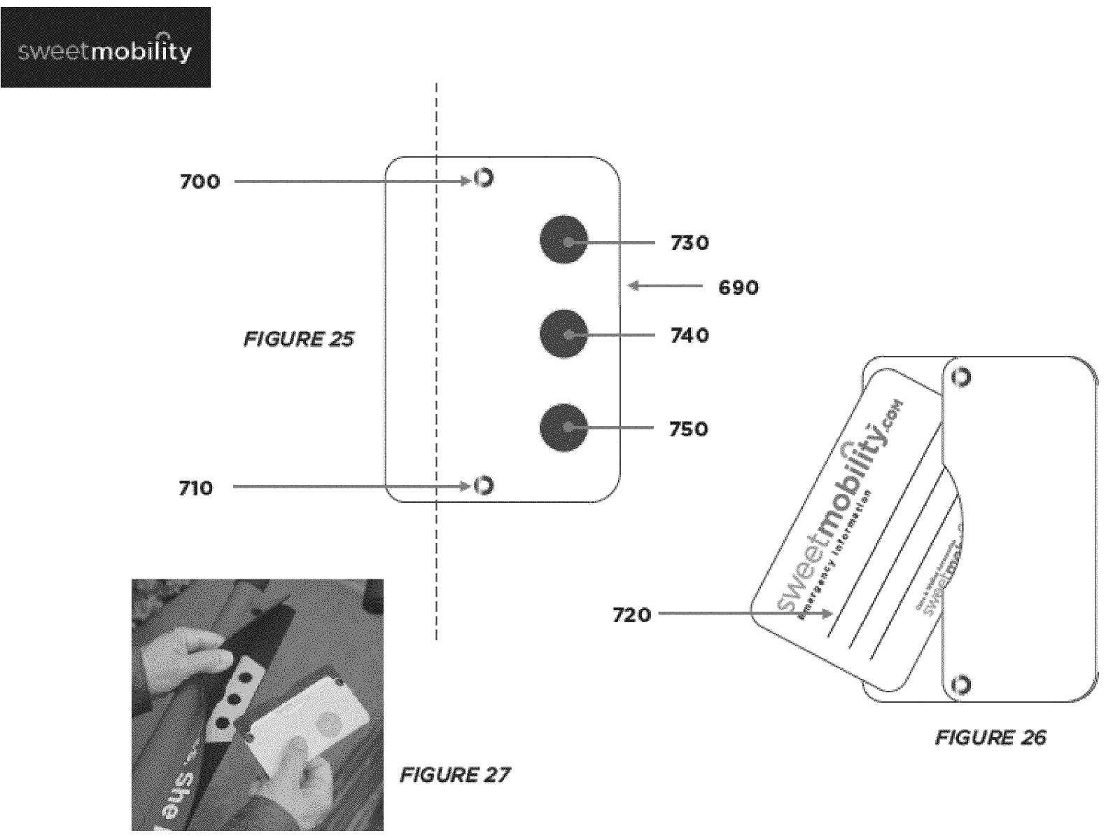

FIG. 22 is a back view of the fabric wrap 100 with a removable and reusable identification card holder (hereinafter ID Card) attached to the body. FIG. 23/24 is the ID Card shown flat with a fold line 690. FIG. 25 is the complete IC Card folded over and riveted together with two metal rivets 700/710. This closure creates a pocket area for a business card 720 to fit into, (FIG. 25). In the back view of the ID Card (FIG. 26) there are three hook and loop fasteners 730/740/750 that allow for the ID Card to be removed and reused. FIG. 27 shows the IC Card being removed or reused.

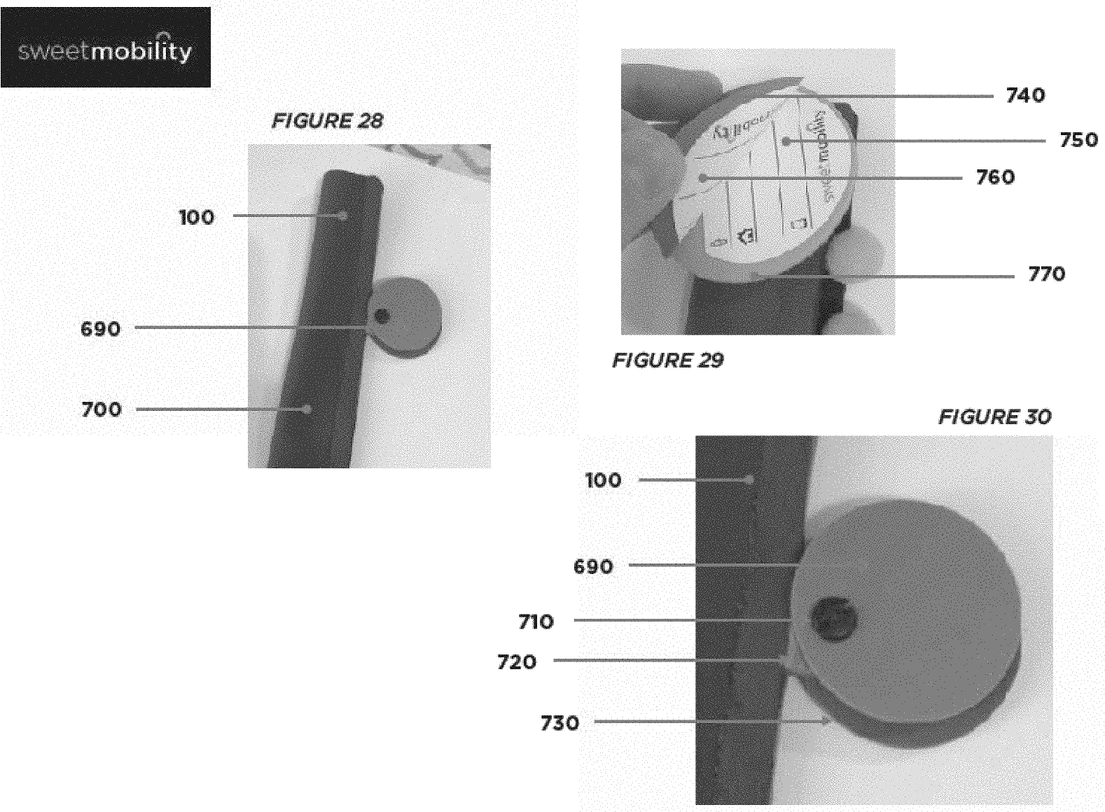

FIG. 28 has circular pieces connected to a fabric wrap 100 to form a protected label (hereinafter label). The label (FIG. 30) is comprised of two pieces of a circular shape 690/730, a folded webbing 720, and a single rivet 710. The (FIG. 291) inside surfaces of the circular shape 740/770 are designed for adhesive-backed labels 750/760. The webbing 720 is captured with the metal rivet 710 to connect the circular pieces 690/730. The label is anchored to the fabric wrap 100 by extending the webbing 720 to be located between the edges of the fabric wrap 100 and captured by stitching the fabric wrap 100 around the cane 110.

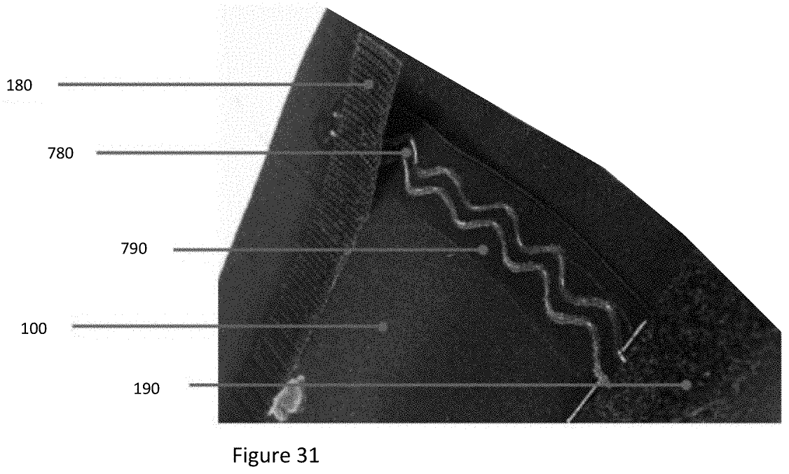

FIG. 31 has a webbing with silicon assembly (hereinafter web) that creates surface tension between the fabric wrap 100 and the cane 110. The silicon 780 is applied to the webbing 790 and then sewn to the fabric wrap across the top and bottom edges of the fabric wrap. The web is located, but not sewn to the full-length stripes hook and loop fasteners 180/190. This assembly of the web to the fabric wrap 100 ensures that the web remains stretchable across the fabric wrap and not be constricted by the hook and loop fastener.

While this invention has been particularly shown and described with references to preferred embodiments thereof, it will be understood by those skilled in the art that various changes in form and details may be made therein without departing from the scope of the invention encompassed by the appended claims.

What is claimed is:

1. A wrap for a mobility device, comprising:
a fabric body; and
a closure system for attaching the fabric body to a shaft of the mobility device.

2. The wrap of claim 1, wherein the fabric body includes stretchable fabric and/or foam.

3. The wrap of claim 1, wherein the closure system includes one or more snaps, hook and loop strips, zipper, elastic cord.

4. The wrap of claim 1, further comprising films on an inner side of the fabric body for preventing the fabric body from sliding down the shaft.

5. The wrap of claim 1, further comprising reflective film elements on the fabric body.

6. The wrap of claim 1, wherein a shape of the fabric body is rectangle with two beveled corners.

7. The wrap of claim 1, further comprising removable and reusable identification card holder.
